(19) United States
(12) Patent Application Publication
(10) Pub. No.: US 2025/0076930 A1
(43) Pub. Date: Mar. 6, 2025

(54) ELECTRONIC DEVICE

(71) Applicant: Lenovo (Beijing) Limited, Beijing (CN)

(72) Inventor: Kai ZHANG, Beijing (CN)

(21) Appl. No.: 18/796,417

(22) Filed: Aug. 7, 2024

(30) Foreign Application Priority Data
Aug. 31, 2023 (CN) 202311117969.2

(51) Int. Cl. G06F 1/16; G09G 3/00

(52) U.S. Cl. CPC G06F 1/1652; G06F 1/166; G09G 3/035; G09G 2354/00

(57) ABSTRACT

A photosensitive chip includes a photosensitive array and a target transmission channel. The photosensitive array is configured to generate an induced electrical signal. A target image signal is generated from the induced electrical signal through the target transmission channel. The target image signal is used to generate a target image. The target image represents a change in a target space.

### CROSS-REFERENCE TO RELATED APPLICATION

The present disclosure claims priority to Chinese Patent Application No. 202311117969.2, filed on Aug. 31, 2023, the entire content of which is incorporated herein by reference.

### TECHNICAL FIELD

The present disclosure relates to the electronic technology field and, more particularly, to an electronic device.

### BACKGROUND

Electronic devices are commonly used devices. In the related technology, an electronic device generally includes two bodies and a display screen. The two bodies are rotatably connected through a connection structure. The display screen is arranged on one of the bodies. The position of the display screen is limited, and the electronic device has poor adaptability.

### SUMMARY

The present disclosure provides an electronic device, including a first body and a second body. The first body includes a first sub-body, a second sub-body rotating relative to the first sub-body, and a flexible screen. The flexible screen includes a first member arranged at the first sub-body, a second member arranged at the second sub-body, and a connection member arranged between the first member and the second member. The first member and the second member rotate through the connection member as the first sub-body and the second sub-body rotate relative to each other. The second body is rotatably connected to an end of the second sub-body away from the first sub-body. The second body rotates relative to the second sub-body to a position meeting a coplanar condition with the second sub-body. An outer contour of a coplanar structure formed by the second body and the second sub-body meet a symmetrical condition with an outer contour of the first sub-body.

### BRIEF DESCRIPTION OF THE DRAWINGS

FIG. 1 illustrates a schematic structural diagram showing an electronic device being in a third open pose according to some embodiments of the present disclosure.

FIG. 2 illustrates a schematic diagram of another view angle of FIG. 1.

FIG. 3 illustrates a schematic structural diagram of an electronic device being in a closed pose according to some embodiments of the present disclosure.

FIG. 4 illustrates a schematic diagram of another view angle of FIG. 3.

FIG. 5 illustrates a schematic structural diagram showing another electronic device being in a third open pose according to some embodiments of the present disclosure.

FIG. 6 illustrates a schematic diagram of another view angle of FIG. 5.

FIG. 7 illustrates a schematic structural diagram showing another electronic device being in a second open pose according to some embodiments of the present disclosure.

FIG. 8 illustrates a schematic diagram of another view angle of FIG. 7.

FIG. 9 illustrates a schematic structural diagram showing another electronic device being in a first open pose according to some embodiments of the present disclosure.

FIG. 10 illustrates a schematic diagram of another view angle of FIG. 9.

FIG. 11 illustrates a schematic structural exploded diagram of an electronic device according to some embodiments of the present disclosure.

Reference numerals:

| | | |
|---|---|---|
| 100 First body | 110 First sub-body | 120 Second sub-body |
| 121 Groove | 130 Flexible screen | 131 First member |
| 132 Second member | 133 Connection member | 140 First connection |
| | | apparatus |
| 200 Second body | 210 Input apparatus | 300 Support part |
| 400 Second connection | | 500 Third connection |
| apparatus | | apparatus |

### DETAILED DESCRIPTION OF THE EMBODIMENTS

The technical solutions of embodiments of the present disclosure are further described in detail in connection with the accompanying drawings and embodiments of the present disclosure.

In embodiments of the present disclosure, unless otherwise specified and described, the term “connection” can be understood in a broad sense. For example, the connection can be an electrical connection or internal communication between two elements, a direct connection or an indirect connection through an intermediate medium. For those ordinary skills in the art, the meaning of the term can be understood according to specific situations.

In embodiments of the present disclosure, the terms “first,” “second,” and “third” are used to distinguish similar objects and do not represent a specific order for the objects. “first,” “second,” and “third” can be interchanged in a specific order or sequence as allowed. Objects distinguished by “first,” “second,” and “third” can be interchanged in an appropriate situation. Thus, embodiments of the present disclosure can be implemented in a sequence other than the order illustrated or described here.

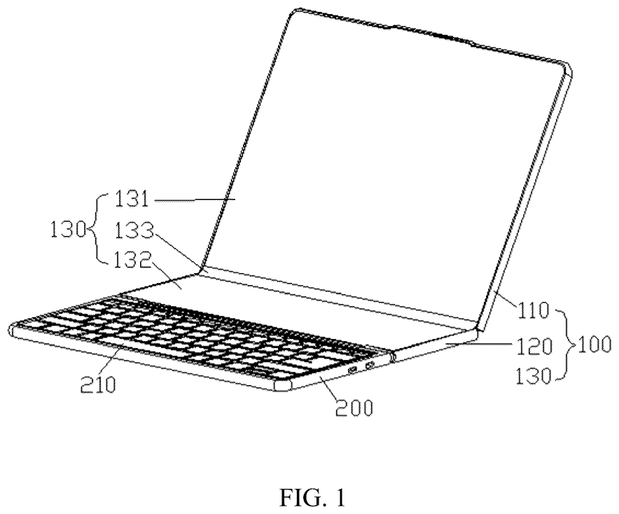

An electronic device of embodiments of the present disclosure is described in detail in conjunction with FIGS. 1 to 11.

The electronic device includes a first body 100, a second body 200, and a flexible screen 130. The first body 100 includes a first sub-body 110 and a second sub-body 120 that can rotate relative to each other. The flexible screen 130 includes a first member 131 arranged at the first sub-body 110, a second member 132 arranged at the second sub-body 120, and a connection member 133 between the first member 131 and the second member 132. The first member 131 and the second member 132 can rotate through the connection member 133 as the first sub-body 110 and the second sub-body 120 rotate relative to each other. The second body 200 is rotatably connected to an end of the second sub-body 120 away from the first sub-body 110. The second body 200 can rotate relative to the second sub-body 120 until the second body 200 and the second sub-body 120 satisfy a coplanar condition. An outer contour of a coplanar structure formed by the second body 200 and the second sub-body 120 can satisfy a symmetrical condition with an outer contour of the first sub-body 110.

In the existing technology, the electronic device can include two bodies and the display screen. The two bodies can be rotatably connected through a connection structure. The display screen can be arranged at one body. The position of the display screen can be limited, and the electronic device can have poor adaptability. The electronic device of embodiments of the present disclosure includes a first body 100 and a second body 200. The first body 100 includes a first sub-body 110 and a second sub-body 120 that can rotate relative to each other. The second body 200 can be rotatably connected to an end of the second sub-body 120 away from the first sub-body 110. The flexible screen 130 can include a first member 131 arranged at the first body 110, a second member 132 arranged at the second sub-body 120, and a connection member 133 arranged between the first member 131 and the second member 132. The first member 131 and the second member 132 can rotate through the connection member 133 as the first sub-body 110 and the second sub-body 120 rotate relative to each other. Since the flexible 130 is arranged at the two sub-bodies, the positions of the flexible screen 130 can be increased. Meanwhile, the outer contour of the coplanar structure formed by the second body 200 and the second sub-body 120 can be symmetrical to the outer contour of the first sub-body 110 to cause the electronic device to form a structure similar to a laptop. Moreover, the second member 132 of the flexible screen 130 can be arranged at the coplanar structure formed by the second body 200 and the second sub-body 120. The first member 131 of the flexible screen 130 can be arranged at the first sub-body 110, and the setting area of the flexible screen 130 can be significantly increased. In addition, the flexible screen 130 can be a whole display screen, and the display effect of the electronic device can be improved.

In embodiments of the present disclosure, the structure of the electronic device is not limited. For example, the electronic device can be a mobile phone, a computer, or a game console.

In embodiments of the present disclosure, the structure of the first sub-body 110 is not limited. For example, the first sub-body 110 can be a plate-shaped structure.

The structure of the second sub-body 120 is not limited. For example, the second sub-body 120 can be a plate-shaped structure.

The first sub-body 110 and the second sub-body 120 can be connected through a first connecting apparatus 140. Thus, the first sub-body 110 and the second sub-body 120 can rotate relative to each other.

The structure of the first connection apparatus 140 is not limited, as long as the first sub-body 110 and the second sub-body 120 can rotate relative to each other through the first connection apparatus 140.

For example, the first connection apparatus 140 can include at least two first rotation shafts. The at least two first rotation shafts can be connected through gear engagement. A first rotation shaft at a first end of the at least two first rotation shafts can be connected to the first sub-body 110 through gear engagement, and a first rotation shaft at a second end of the at least two first rotation shafts can be connected to the second sub-body 120 through gear engagement.

For example, the first connection apparatus 140 can have a watchband-type structure.

In embodiments of the present disclosure, the flexible screen 130 can have an integrated structure. The first member 131 of the flexible screen 130 can be arranged at the first sub-body 110 by glue or a snap structure. The second member 132 of the flexible screen 130 can be arranged at the second sub-body 120 by glue or a snap structure. The first member 131 and the second member 132 of the flexible screen 130 can be in a planar shape.

The connection member 133 of the flexible screen 130 can be arranged at the first connection apparatus 140. The first connection apparatus 140 can be configured to support the connection member 133 of the flexible screen 130 and can be in a planar shape or a curved shape.

In embodiments of the present disclosure, the structure of the second body 200 is not limited. For example, the second body 200 can have a plate-shaped structure.

The second body 200 can be connected to the second sub-body 120 through a second connection apparatus 400. Thus, the second body 200 and the second sub-body 120 can be rotatably connected.

The structure of the second connection apparatus 400 is not limited, as long as the second body 200 and the second sub-body 120 can rotate relative to each other.

For example, the second connection apparatus 400 can have a rotation shaft structure. For another example, the second connection apparatus 400 can have a hinge structure.

The second body 200 can rotate relative to the second sub-body 120 until the second body 200 and the second sub-body 120 are coplanar. That is, the second body 200 and the second sub-body 120 can be coplanar or substantially coplanar. The coplanar structure formed by the second body 200 and the second sub-body 120 can be similar to a plate.

The outer contour of the coplanar structure formed by the second body 200 and the second sub-body 120 can be symmetrical with the outer contour of the first sub-body 110. That is, the outer contour of the coplanar structure formed by the second body 200 and the second sub-body 120 is symmetrical or substantially symmetrical to the outer contour of the first sub-body 110.

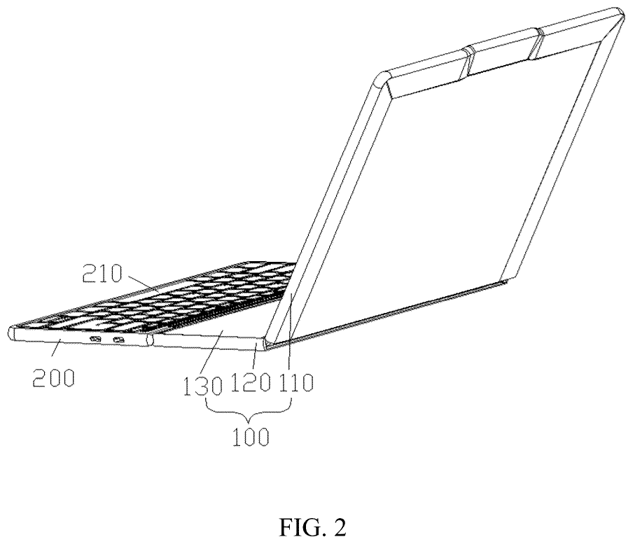

For example, as shown in FIG. 1 and FIG. 2, the coplanar structure formed by the second body 200 and the second sub-body 120 is similar to the body of a conventional laptop where the keyboard is located. The first sub-body 110 is similar to the body of the conventional laptop where the display screen is located. However, in the present disclosure, the flexible screen 130 is arranged at the coplanar structure formed by the second body 200, the second sub-body 120, and the first sub-body 110.

The coplanar condition can include being coplanar or substantially coplanar. The symmetrical condition can include being symmetrical or substantially symmetrical.

The second body 200 and the second sub-body 120 can rotate about a first axis. The second sub-body 120 and the first sub-body 110 can rotate about a second axis. The first axis and the second axis can meet a parallel condition. Thus, the second body 200, the second sub-body 120, and the first sub-body 110 can rotate in parallel.

In some embodiments, the first axis and the second axis may not meet the parallel condition. The parallel condition can include being parallel or substantially parallel.

In embodiments of the present disclosure, at least two of the second body 200, the second sub-body 120, and the first sub-body 110 can meet the coplanar condition. That is, the second body 200, the second sub-body 120, and the first sub-body 110 can meet the coplanar condition, the second body 200 and the second sub-body 120 can meet the coplanar condition. The second sub-body 120 and the first sub-body 110 can meet the coplanar condition. Thus, the electronic device can have different poses.

In some other embodiments, the second body 200, the second sub-body 120, and the first sub-body 110 may not be coplanar.

For example, the first sub-body 110 can rotate relative to the second sub-body 120 to a position neighboring to the front surface or the back surface of the second sub-body 120.

The front surface of the second sub-body 120 can have the first member 131 of the flexible screen 130. The front surface of the first sub-body 110 can have the second member 132 of the flexible screen 130.

The first sub-body 110 and the second body 200 can be arranged on different sides of the second sub-body 120.

For example, the first sub-body 110 can be arranged at the back surface of the second sub-body 120, and the second body 200 can be arranged at the front surface of the second sub-body 120.

For another example, the second body 200 can rotate relative to the second sub-body 120 to a position neighboring to the front surface or back surface of the second sub-body 120.

In some embodiments, the first sub-body 110 can be arranged at the front surface of the second sub-body 120, and the second body 200 can be arranged at the back surface of the second sub-body 120.

In some embodiments, the first sub-body 110 and the second body 200 can be arranged on different sides of the second sub-body 120 and neighboring to the second sub-body 120. Thus, the first sub-body 110, the second sub-body 120, and the second body 200 can be folded together to reduce the occupied space of the electronic device.

In some other embodiments, the first sub-body 110 and the second sub-body 120 can meet the coplanar condition. The second body 200 can be arranged at the back surface of the second sub-body 120. Thus, the second body 200 can support the first body 100 by abutting against a support surface.

In some embodiments of the present disclosure, the electronic device can further include an input apparatus 210. The input apparatus 210 can be arranged at the second body 200. The flexible screen 130 can be neighboring to the input apparatus 210. Thus, the electronic device can perform an input operation through the input apparatus 210.

In some embodiments, the structure of the input apparatus 210 is not limited. For example, the input apparatus 210 can be a mechanical keyboard. For another example, the input apparatus 210 can be an electronic keyboard. For another example, the input apparatus 210 can be a touch screen.

The input apparatus 210 can be fixed to the second body 200. The input apparatus 210 can be detachably connected to the second body 200 through a snap structure or a magnetic structure. In some embodiments, the input apparatus 210 can be rotatably connected to the second body 200 through a rotation shaft structure. Thus, the input apparatus 210 can rotate relative to the second body 200.

In embodiments of the present disclosure, since the electronic device includes three structures that can rotate relative to each other, such as the first sub-body 110, the second sub-body 120, and the second body 200, the electronic device can represent various poses based on the relative rotation between the first sub-body 110 and the second sub-body 120 and the relative rotation between the second body 200 and the second sub-body 120.

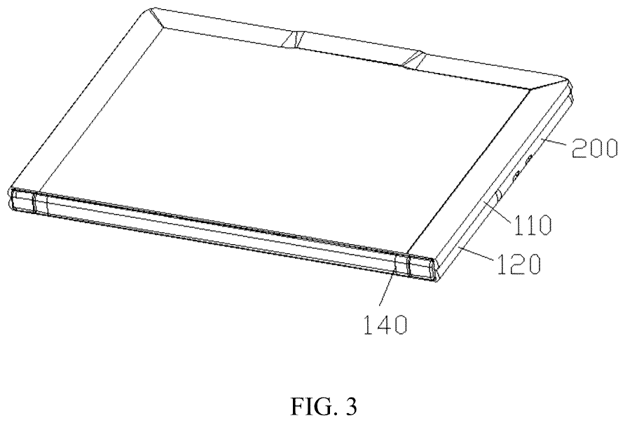

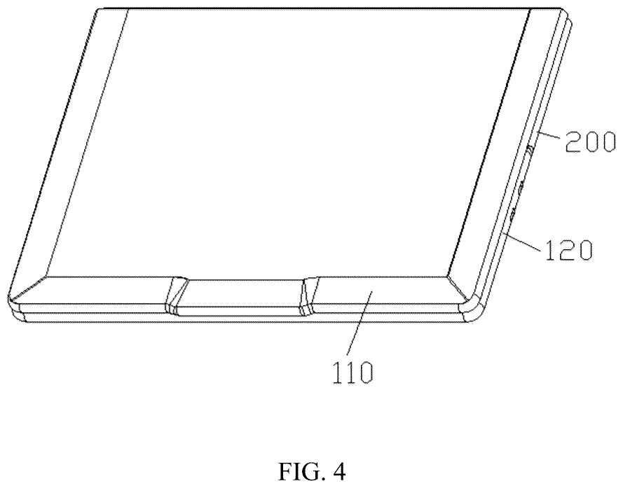

In some embodiments, as shown in FIGS. 3 and 4, the electronic device has a closed pose. In the closed pose, the coplanar structure formed by the second body 200 and the second sub-body 120 is neighboring to the first sub-body 110. The flexible screen 130 can be in a hidden state. Since the outer contour of the coplanar structure formed by the second body 200 and the second sub-body 120 is symmetrical with the outer contour of the first sub-body 110, the electronic device can have a smaller volume than the two asymmetrical structures being in the closed state. The electrical device can be facilitated for storage and carry. Meanwhile, the electronic device as a whole can have a structure similar to a rectangular shape. Thus, the electronic device can be more neat.

The first member 131 of the flexible screen 130 and the second member 132 of the flexible screen 130 can be arranged opposite and neighboring to each other.

The input apparatus 210 can be in a hidden state and arranged opposite and neighboring to the first member 131 of the flexible screen 130.

For example, the first sub-body 110 and the second sub-body 120 can form a zero angle. The first sub-body 110 and the second body 200 can form a zero angle. The second sub-body 120 and the second body 200 can form a 180° angle.

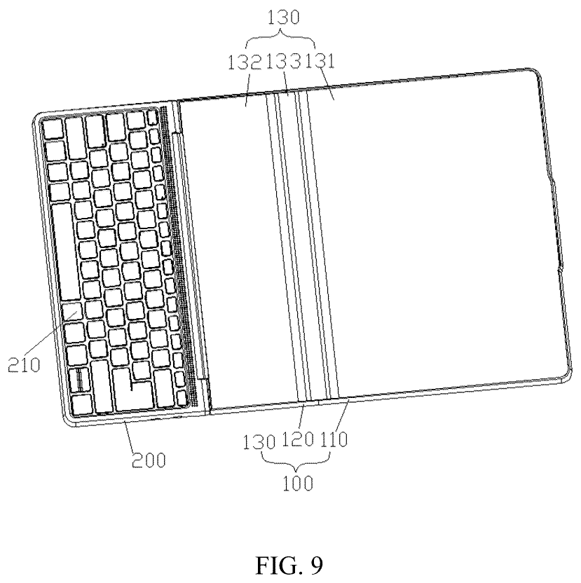

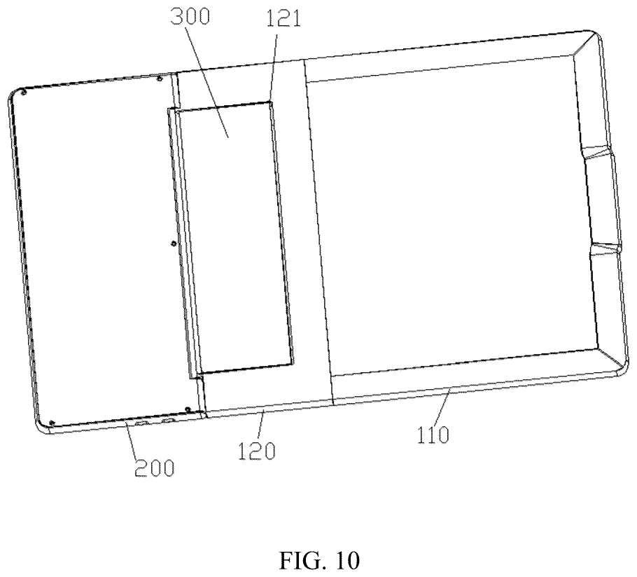

In some embodiments, as shown in FIGS. 9 and 10, the electronic device includes a first open pose. In the first open pose, the second body 200, the second sub-body 120, and the first sub-body 110 meet the coplanar condition. Thus, the electronic device forms a tablet structure.

The flexible screen 130 as a whole can be in a tablet shape. Thus, the electronic device can have the largest display screen in the tablet shape.

The flexible screen 130 and the input apparatus 210 are arranged at the same side of the coplanar structure formed by the second body 200, the second sub-body 120, and the first sub-body 110.

For example, the first sub-body 110 and the second sub-body 120 can form a 180° angle, and the second sub-body 120 and the second body 200 can also form a 180° angle.

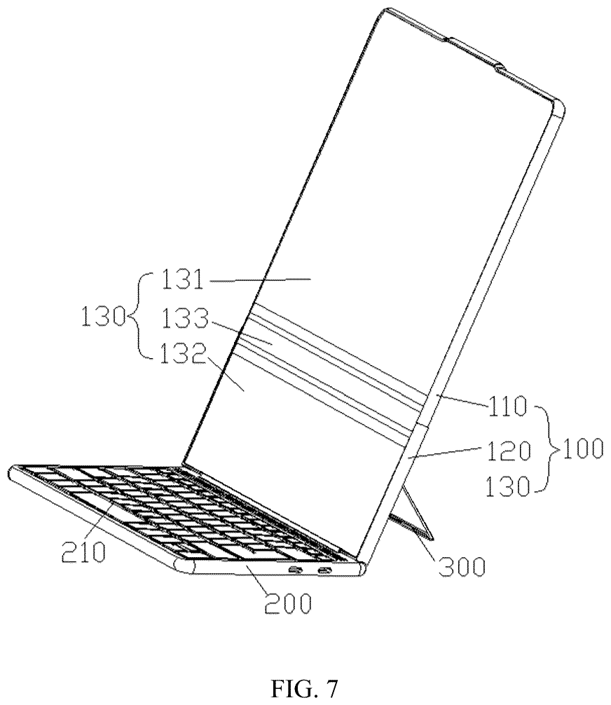

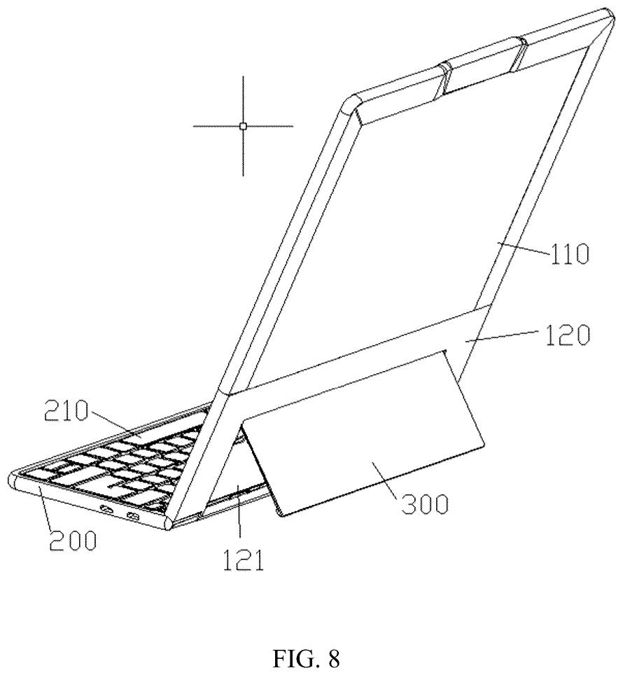

In some embodiments, as shown in FIGS. 7 and 8, the electronic device has a second open pose. In the second open pose, the first sub-body 110 and the second sub-body 120 meet the coplanar condition, and the second body 200 and the second sub-body 120 form a first angle. Thus, the flexible screen 130 as a whole can be in a tablet shape. The electronic device can have the largest display screen in the tablet shape. The electronic device can be supported by the second body 200 abutting against the support surface.

As shown in FIGS. 7 and 8, the second body 200 is arranged at the front surface of the second sub-body 120. Of course, the second body 200 can also be arranged at the back surface of the second sub-body 120. Then, the second body 200 can abut against the support surface through the input apparatus 210. The input apparatus 210 can be electrically disconnected from the processor. That is, the input apparatus 210 may not have the input function, no error input operation can be generated when the input apparatus 210 abuts against the support surface.

The electronic device can have the structure similar to a laptop. The display screen in the tablet shape formed by the flexible screen 130 can have a relatively large area.

The support surface can refer to the surface for supporting the electronic device. For example, the support surface can be a table surface.

When the second body 200 is arranged at the front surface of the second sub-body 120, since the second body 200 abuts against the support surface, the input operation can be performed stably through the input apparatus 210.

The value of the first angle is not limited. For example, the first angle can range from 70° to 110°. For example, the first angle can be 70° or 120°.

The electronic device can also include a support part 300. The support part 300 can be movably arranged on a side of the second sub-body 120 facing away from the second member 132 of the flexible screen 130. As shown in FIG. 7 and FIG. 8, in the second open pose, the support member 300 and the second body 200 abut against the support surface to support the first body 100.

The structure of the support part 300 is not limited. For example, the support member 300 can be a plate-shaped structure.

The support part 300 can be movably or rotatably arranged on the side of the second sub-body 120 facing away from the second member 132 of the flexible screen 130.

The first end of the support part 300 can be movably connected to the second sub-body 120. The second end of the support part 300 can move to be attached to the side of the second sub-body 120 facing away from the flexible screen 130. The second end of the support part 300 can also move away from the side of the second sub-body 120 facing away from the flexible screen 130 to abut against the support surface.

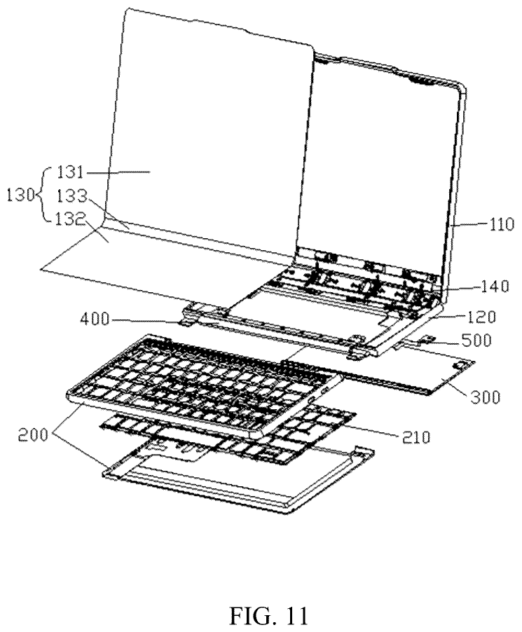

In some embodiments, as shown in FIG. 11, the support part 300 is rotatably connected to the second sub-body 120 through the third connection apparatus 500.

The structure of the third connection apparatus 500 is not limited. For example, the third connection apparatus 500 can have a rotation shaft structure or a hinge structure.

The side of the second sub-body 120 facing away from the flexible screen 130 can be the back surface of the second sub-body 120.

In some embodiments, the back surface of the second sub-body 120 can include a groove 121. The support part 300 can move relative to the second sub-body 120 into the groove. As shown in FIG. 10, the outer surface of the support part 300 is flush with the outer surface of the second sub-body 120, or the support part 300 can be recessed into the second sub-body 120. Thus, the groove 121 can accommodate the support part 300, and the support part 300 may not affect the second sub-body 120.

In some embodiments, as shown in FIGS. 1 and 2, the electronic device has a third open pose. In the third open pose, the first sub-body 110 and the second sub-body 120 form a second angle, and the second body 200 and the second sub-body 120 meet the coplanar condition. The electronic device forms a laptop structure. The coplanar structure formed by the second body 200 and the second sub-body 120 also includes the second member 132 of the flexible screen 130.

The second body 200 and the second sub-body 120 can abut against the support surface to support the first sub-body 110. The second sub-body 120 may also not abut against the support surface.

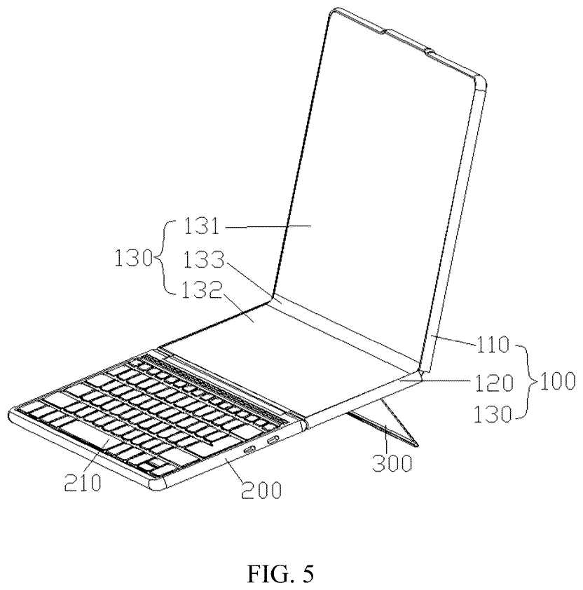

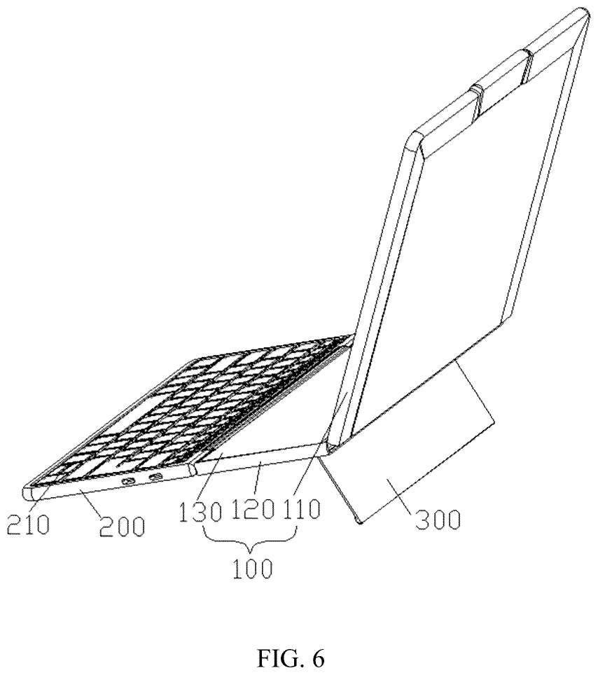

As shown in FIGS. 5 and 6, in the third open pose, the support part 300 and the second body 200 abut against the support surface to support the first sub-body 110 to lift the second sub-body 120 through the support part 300 to form a gap between the second sub-body 120 and the support surface to allow the electronic device to dissipate heat. Meanwhile, the second sub-body 120 is lifted by the support part 300 to cause the coplanar structure formed by the second sub-body 120 and the second body 200 to be in an inclined state to facilitate the input operation of the input apparatus 210.

Of course, the support part 300 can also be arranged inside the groove 121 to form the support state shown in FIGS. 1 and 2.

The value of the second angle is not limited. For example, the value of the second angle can range from 70° to 130°. For example, the second angle can be 120°.

In embodiments of the present disclosure, the electronic device can also include a processor. The processor can be configured to control the first member 131 and the second member 132 to display different portions of the first image data or different pieces of image data to improve the display mode of the flexible screen 130.

In some embodiments, the processor can be arranged at the first sub-body 110, the second sub-body 120, or the second body 200.

In some embodiments, the processor can control the first member 131 and the second member 132 to display different portions of the first image data to enlarge the display area of the electronic device. Then, the first member 131 and the second member 132 can satisfy the coplanar condition. As shown in FIG. 7 and FIG. 9, the flexible screen 130 has a tablet structure. In some other embodiments, as shown in FIG. 1 and FIG. 5, the first member 131 and the second member 132 do not satisfy the coplanar condition.

In some embodiments, the processor can control the first member 131 and the second member 132 to display different pieces of image data to enlarge the number of display screens of the electronic device. Then, as shown in FIG. 1 and FIG. 5, the first member 131 and the second member 132 do not meet the coplanar condition. In some other embodiments, as shown in FIG. 7 and FIG. 9, the first member 131 and the second member 132 meet the coplanar condition, and the flexible screen 130 has a tablet structure.

In some embodiments of the present disclosure, the second body 200 and the second sub-body 120 can be detachably connected. The second body 200 and the second sub-body 120 can have a detached state and a connected state. In the connected state, the second body 200 can rotate relative to the second sub-body 120. In the detached state, the first body 100 and the second body 200 can be arranged at different positions to facilitate the flexible use of the electronic device.

In some embodiments, in the detached state, the flexible screen 130 and the input apparatus 210 can be electrically connected in a wireless manner. Thus, the first body 100 can be arranged at a relatively high position to facilitate the operator to review the display content of the flexible screen 130. The second body 200 can be arranged at a relatively low position to facilitate the input operation of the input apparatus 210.

Of course, in the detached state, the flexible screen 130 and the input apparatus 210 can also be electrically disconnected. Then, the first body 100 and the second body 200 can be stored separately to make the storage convenient.

In some embodiments, the method for the detachable connection between the second body 200 and the second sub-body 120 is not limited. For example, the second connection apparatus 400 can include a slot. The second sub-body 120 can be inserted into the slot. When the second sub-body 120 is inserted into the slot, the second sub-body 120 can rotate relative to the second body 200 through the second connection apparatus 400. When the second sub-body 120 is pulled out from the slot, the second sub-body 120 can be detached from the second body 200.

The above are merely some embodiments of the present disclosure. The scope of the present disclosure is not limited to this. Those skilled in the art can easily think of modifications or replacements. The modifications and replacements are within the scope of the present disclosure. The scope of the present disclosure should conform to the scope of the claims.

What is claimed is:

1. An electronic device comprising:
a first body including:
a first sub-body;
a second sub-body rotating relative to the first sub-body; and
a flexible screen including:
a first member arranged at the first sub-body,
a second member arranged at the second sub-body, and
a connection member arranged between the first member and the second member, the first member and the second member rotating through the connection member as the first sub-body and the second sub-body rotate relative to each other; and
a second body rotatably connected to an end of the second sub-body away from the first sub-body, the second body rotating relative to the second sub-body to a position meeting a coplanar condition with the second sub-body, and an outer contour of a coplanar structure formed by the second body and the second sub-body meeting a symmetrical condition with an outer contour of the first sub-body.

2. The electronic device according to claim 1, wherein at least two of the second body, the second sub-body, and the first sub-body meet the coplanar condition.

3. The electronic device according to claim 1, further comprising:
a closed pose, in the closed pose, the coplanar structure formed by the second body and the second sub-body being neighboring to the first sub-body, and the flexible screen being in a hidden state; and
a first open pose, in the first open pose, the second body, the second sub-body, and the first sub-body meeting the coplanar condition.

4. The electronic device according to claim 1, further comprising a second open pose, wherein:
in the second open pose, the first sub-body and the second sub-body meet the coplanar condition, and the second body forms a first angle with the second sub-body.

5. The electronic device according to claim 4, further comprising:
a support part movably arranged on a side of the second sub-body facing away from the second member, in the second open pose, the support part and the second body abutting against a support surface to support the first body.

6. The electronic device according to claim 1, further comprising:
a third open pose, wherein:
in the third open pose, the first sub-body and the second sub-body form a second angle, and the second body and the second sub-body meet the coplanar condition; and
a support part movably arranged on a side of the second sub-body facing away from the second member, in the third open pose, the support part and the second body abutting against a support surface to support the first sub-body.

7. The electronic device according to claim 1, wherein:
the first sub-body rotates relative to the second sub-body to a position neighboring to a front surface or a back surface of the second sub-body; and
the second body rotates relative to the second sub-body to a position neighboring to the front surface or the back surface of the second sub-body.

8. The electronic device according to claim 1, further comprising:
a processor configured to control the first member and the second member to display different portions of first image data or different pieces of image data; and
an input apparatus arranged at the second body, the flexible screen being neighboring to the input apparatus.

9. The electronic device according to claim 1, wherein:
the second body is detachably connected to the second sub-body;
the second body and the second sub-body have a detached state and a connected state; and
in the connected state, the second body rotates relative to the second sub-body.

10. The electronic device according to claim 1, wherein:
the second body and the second sub-body rotate about a first axis;
the second sub-body and the first sub-body rotate about a second axis; and
the first axis and the second axis meet a parallel condition.
